(19) United States
(12) Patent Application Publication
(10) Pub. No.: US 2024/0185204 A1
(43) Pub. Date: Jun. 6, 2024

(54) INFORMATION PROCESSING APPARATUS, INFORMATION PROCESSING METHOD, AND RECORDING MEDIUM

(71) Applicant: NEC Corporation, Tokyo (JP)

(72) Inventors: Yuta DENCHIDA, Tokyo (JP); Osamu NISHIMURA, Tokyo (JP)

(73) Assignee: NEC Corporation, Tokyo (JP)

(21) Appl. No.: 18/521,158

(22) Filed: Nov. 28, 2023

(30) Foreign Application Priority Data
Dec. 1, 2022 (JP) 2022-192786

(51) Int. Cl. G06Q 20/20

(52) U.S. Cl. CPC G06Q 20/20

(57) ABSTRACT

An information processing apparatus includes a memory storing instructions, and one or more processors configured to execute the instructions to acquire at least one of information indicating a payment method used by a customer who intends to use a payment device and information indicating a registration method of a product of the customer as customer information, acquire a status of a payment device including at least one of information indicating a payment method available in the payment device and information indicating a registration method of a product available in the payment device and an operation status of the payment device, and output guidance information indicating a payment device conforming to the customer information based on the customer information and the status.

This application is based upon and claims the benefit of priority from Japanese Patent Application No. 2022-192786, filed on Dec. 1, 2022, the disclosure of which is incorporated herein in its entirety by reference.

### TECHNICAL FIELD

The present invention relates to an information processing apparatus, an information processing method, a recording medium storing an information processing program, and the like.

### BACKGROUND ART

Japanese Patent Application Laid-open Publication No. 2019-021242 disclosures a technology in which a payment device determines whether each of a plurality of payment methods that can be handled by the own payment device is in an available state, and displays each of the payment methods determined to be available on a display unit.

### SUMMARY

An object of the present disclosure is to provide a technology for guiding the customer to an appropriate payment device.

According to an aspect of the present disclosure, there is provided an information processing apparatus including: a customer information acquisition means that acquires at least one of information indicating a payment method used by a customer who intends to use a payment device and information indicating a registration method of a product of the customer as customer information; a status acquisition means that acquires a status of a payment device including at least one of information indicating a payment method available in the payment device and information indicating a registration method of a product available in the payment device and an operation status of the payment device; and an output means that outputs guidance information indicating a payment device conforming to the customer information based on the customer information and the status.

According to an aspect of the present disclosure, there is provided an information processing method by a computer, the information processing method including: acquiring at least one of information indicating a payment method used by a customer who intends to use a payment device and information indicating a registration method of a product of the customer as customer information; acquiring a status of a payment device including at least one of information indicating a payment method available in the payment device and information indicating a registration method of a product available in the payment device and an operation status of the payment device; and outputting guidance information indicating a payment device conforming to the customer information based on the customer information and the status.

According to an aspect of the present disclosure, there is provided a recording medium that stores an information processing program for causing a computer to execute: acquiring at least one of information indicating a payment method used by a customer who intends to use a payment device and information indicating a registration method of a product of the customer as customer information; acquiring a status of a payment device including at least one of information indicating a payment method available in the payment device and information indicating a registration method of a product available in the payment device and an operation status of the payment device; and outputting guidance information indicating a payment device conforming to the customer information based on the customer information and the status.

### BRIEF DESCRIPTION OF THE DRAWINGS

Exemplary features and advantages of the present invention will become apparent from the following detailed description when taken with the accompanying drawings in which:

FIG. 1 is a diagram illustrating a configuration of a system including an information processing apparatus;

FIG. 2 is a block diagram illustrating a functional configuration of the information processing apparatus;

FIG. 3 is a diagram illustrating an input screen example of a payment method;

FIG. 4 is a diagram illustrating an example of a customer information database;

FIG. 5 is a diagram illustrating an example of a status of the payment device;

FIG. 6 is a diagram illustrating an example of an output screen;

FIG. 7 is a flowchart illustrating the operation of the information processing apparatus; and

FIG. 8 is a diagram illustrating a hardware configuration in which the information processing apparatus according to the present disclosure is implemented by a computer device and peripheral devices of the computer device.

### EXAMPLE EMBODIMENT

Next, a detailed explanation will be given for a first example embodiment with reference to the drawings.

The present disclosure relates to a technology of guiding a customer who intends to use a payment device to a payment device available to a customer in a retail store.

An information processing apparatus, an information processing method, and a program according to the present disclosure guide a customer to a payment device available to the customer based on customer information and POS (Point Of Sales) data. Here, the POS data is data indicating an operation status of a POS terminal. The POS data may include other information such as sales information of a product. Examples of the retail store include, but are not particularly limited to, a supermarket, a convenience store, a drug store, an apparel shop, an electric appliance mass retailer, a home center, and the like. The payment device is a device that makes payment when a customer who uses a retail store purchases a product. In the present disclosure, the payment device may be a payment device in which a customer himself/herself registers and performs payment for a purchased product, a payment device that performs only payment for a purchased product for which a product has already been registered, or a payment device in which a clerk handles a process from registration of a purchased product to payment. The payment device is not limited thereto.

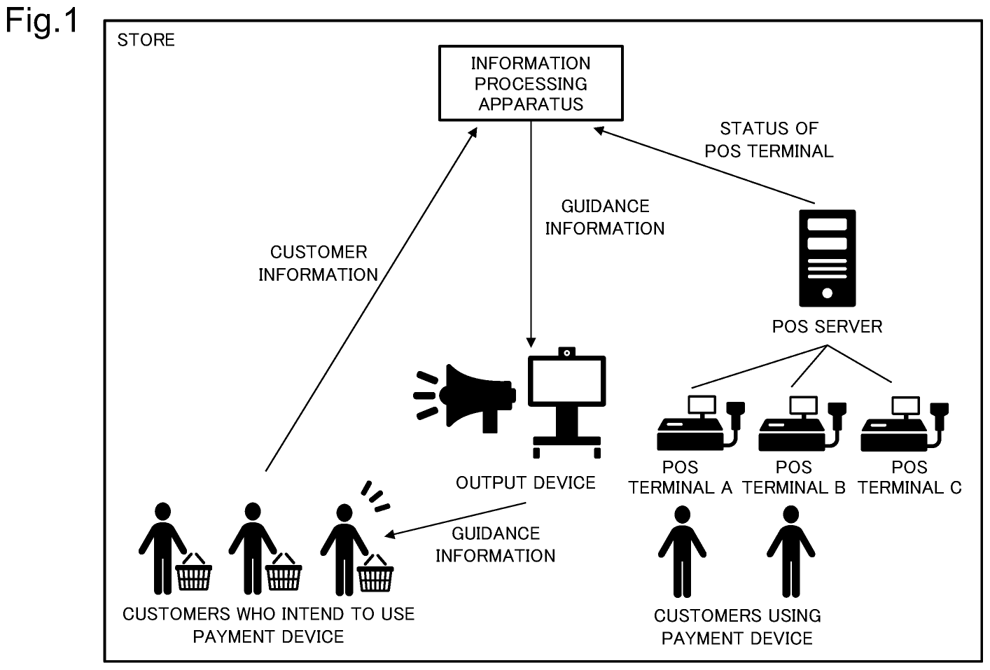

FIG. 1 is a diagram illustrating an example of a system including an information processing apparatus of the present disclosure.

In FIG. 1, the information processing apparatus acquires POS data from a POS terminal of a store. The information processing apparatus acquires customer information from various apparatuses for acquiring customer information. Examples of the various devices for acquiring customer information include, but are not limited to, a terminal device, a camera for photographing a customer, and a customer information database. As illustrated in FIG. 1, the information processing apparatus may acquire POS data from a POS terminal via a POS server that collects POS data of a store. The inside of the store may be an area that a customer can enter in the site of the store. For example, the inside of a store may include not only a sales room of the store or a building including the sales room but also, for example, a parking lot of the store.

The information processing apparatus outputs, to an output device, guidance information for guiding the customer to the payment device available to the customer. The output device is not particularly limited as long as it is a device that outputs the guidance information so that the customer can recognize the guidance information. The output device may be, for example, a display device installed in a store, a voice output device installed in a store, a terminal device installed in a store, or a terminal device used by a customer.

In FIG. 1, the information processing apparatus is provided in the store. The information processing apparatus may be provided outside the store and communicably connected to a POS terminal, an output device, and various devices for acquiring customer information. The information processing apparatus may be included in a POS server. The POS server including the information processing apparatus may be provided outside the store and communicably connected to a POS terminal, an output device, and various devices for acquiring customer information.

Next, an example in which a system including the information processing apparatus of FIG. 1 is used will be described from the customer side.

A customer who intends to use the payment device approaches the payment device. Here, it is assumed that a plurality of payment devices is provided. In a case where the payment device is available among the plurality of payment devices, the customer who intends to use the payment device moves to the available payment device and starts payment. In a case where the payment device is not available, or in a case where the customer does not notice that the payment device is available and determines that the payment device is not available, the customer who intends to use the payment device waits for availability of the payment device.

In FIG. 1, a customer who intends to use a payment device waits for availability of the payment device near the payment device. There is a case where it is difficult for a customer waiting for a vacant spot to see whether the payment device is vacant in order to use the payment device. For example, in the case of FIG. 1, it is difficult to visually recognize a POS terminal C installed at the back. Even when the POS terminal is available, there is a case where it is not clear whether a payment method or a product registration method desired to be used by the customer can be used. Meanwhile, in FIG. 1, the information processing apparatus specifies that the POS terminal C is available and the POS terminal C is a POS terminal available to the customer based on the customer information of the customer and the status of the payment device. Then, the information processing apparatus outputs guidance information indicating the POS terminal C that is a payment device conforming to the customer information. The output device outputs information for guiding the POS terminal C to a customer who intends to use the payment device. As a result, the customer can recognize that the POS terminal C is available. The customer moves to the POS terminal C, which is an available payment device, and starts payment.

Next, a configuration of the information processing apparatus 100 according to the example embodiment will be described.

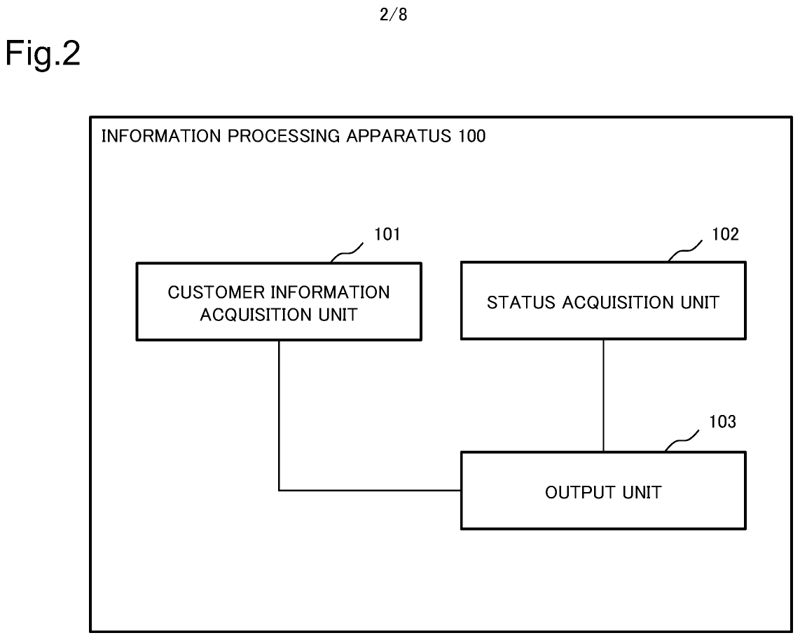

FIG. 2 is a block diagram illustrating a configuration of the information processing apparatus 100 according to the example embodiment. Referring to FIG. 2, the information processing apparatus 100 includes a customer information acquisition unit 101, a status acquisition unit 102, and an output unit 103.

Next, each configuration of the information processing apparatus 100 according to the example embodiment will be described in detail.

In FIG. 1, the customer information acquisition unit 101 is an example of a customer information acquisition means that acquires at least one of information indicating a payment method used by a customer who intends to use a payment device and information indicating a registration method of a purchased product of the customer as customer information. The payment method is a method used by a customer to pay for a purchased product. The payment method is, for example, cash, a credit card, a debit card, a gift certificate, electronic money, a code payment, or the like. The type of payment method is not limited thereto. The payment method may include availability of a recharge function for depositing money into electronic money.

First, a method in which the customer information acquisition unit 101 acquires information indicating a payment method used by a customer who intends to use a payment device will be described.

The method of acquiring the information indicating the payment method is, for example, a method of acquiring a payment method that the customer desires to use based on an input by the customer. For example, on an input screen of the payment method displayed on the terminal device, the payment method selected by the customer is acquired as the payment method that the customer desires to use.

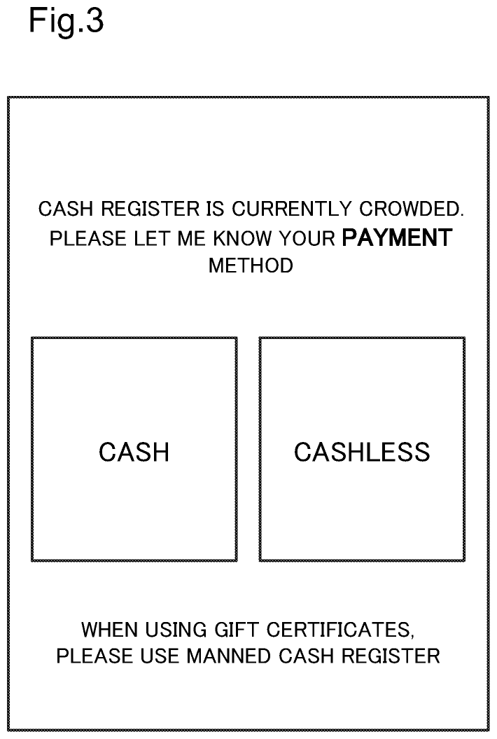

FIG. 3 is a screen example of an input screen of the payment method. An option of the payment method is displayed on the payment method input screen. In FIG. 3, the option of the payment method is “cash” or “cashless”. The cashless as a payment method may be a payment method other than cash. For example, the cashless includes a credit card, electronic money, and code payment. The type or classification of the payment method is not limited to the example of FIG. 3. The payment method input screen may include guidance regarding a payment method without a guidable payment device. In FIG. 3, the example of the input screen of the payment method includes information for guiding the clerk to use the payment device that performs the payment operation for “gift certificate” that is the payment method unavailable in the payment device in which the customer performs the payment operation.

The payment method may be input via, for example, a terminal device installed at a place where the customer waits for availability of the payment device. The type of the terminal device is not particularly limited as long as the payment method can be input. The terminal device displays the payment method on the input screen. The terminal device may display the input screen of the payment method when a customer who intends to use the payment device is detected by a sensor or the like. Alternatively, in a case where a customer who intends to use the payment device is detected by a sensor or the like, the terminal device may change the state to a state in which the input operation of the payment method can be performed. The sensor may be, for example, a sensor that can detect the presence or absence of a person in a certain place, such as a camera or a human sensor. The information processing apparatus 100 or the terminal device may acquire information indicating the presence or absence of a person detected by the sensor, and display the input screen on the display unit of the terminal device.

Alternatively, the payment method may be input by a terminal device for self-scanning used by the customer. The self-scan is a product registration method in which a customer registers a purchased product by scanning using a terminal device while shopping in a store. In the case of the self-scan, the customer performs the payment after the product registration using the payment device. The terminal device for self-scan may be provided in a shopping cart or the like of a store, or may be a terminal device owned by a customer that can use a self-scan function. In a case where the payment method is input by the terminal device for self-scanning, for example, the terminal device may display the input screen of the payment method in a case where its own position is included in a place waiting for availability of the payment device by near field communication or the like.

The customer information acquisition unit 101 acquires the information indicating the payment method input by the customer in this manner as the customer information.

Another example of the method of acquiring the information indicating the payment method by the customer information acquisition unit 101 is, for example, a method of acquiring information indicating a payment method associated with identification information for specifying a customer. In this case, the information indicating the payment method selected as the payment method desired to be used by the customer may be associated with the identification information of the customer in advance. The identification information of the customer is, for example, a face image of the customer or an identification number of the customer. The customer information may be stored in a customer information database communicably connected to the inside or the outside of the information processing apparatus 100.

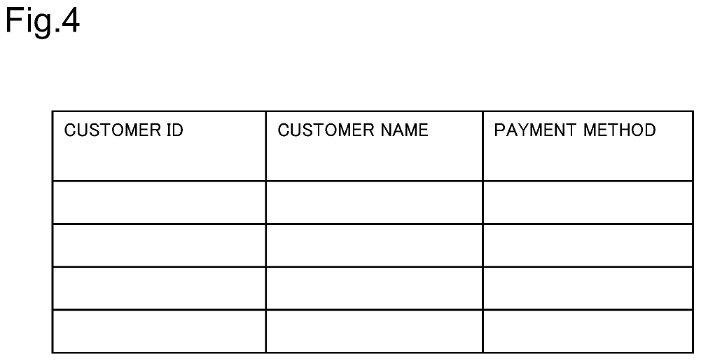

FIG. 4 is an example of the customer information database. The customer ID (Identifier) is identification information of the customer. In FIG. 4, information indicating the payment method of the customer is associated with identification information of the customer. The customer information database may include other information such as a name of a customer, point information of the customer, and a purchase history of the customer.

For example, the customer information acquisition unit 101 acquires an image obtained by photographing a customer who intends to use the payment device from a camera communicably connected. Then, the customer information acquisition unit 101 collates a face authentication image of the customer stored in advance in the customer information database with the face image of the customer included in the photographed image. The customer information acquisition unit 101 specifies identification information including a matched face authentication image by collation. The customer information acquisition unit 101 acquires, from the customer information database, information indicating the customer's payment method associated with the specified identification information.

For example, the customer information acquisition unit 101 acquires the identification number of the customer who intends to use the payment device from a reading device that reads the barcode including the identification number of the customer. The reading device is, for example, a camera or a barcode reader. Then, the customer information acquisition unit 101 refers to the customer information database to acquire information indicating the payment method of the customer associated with the identification number. The reading device that reads the barcode including the identification number of the customer may be provided inside a terminal device installed at a place where the customer waits for availability of the payment device, or inside a display device such as a display or outside a communicably connected display device. The customer information acquisition unit 101 may acquire the identification number via the terminal device or the display device installed in the place where the customer waits for availability of the payment device.

As described above, the customer information acquisition unit 101 may acquire information indicating the payment method of the customer. Although a plurality of examples of the method of acquiring the information indicating the payment method of the customer have been described, the customer information acquisition unit 101 may appropriately use the plurality of methods. For example, in a case where the information indicating the payment method of the customer cannot be acquired from the face image of the customer, the customer information acquisition unit 101 may acquire the identification number by reading the barcode including the identification number. For example, in a case where the information indicating the payment method by the customer is not registered in advance, the customer information acquisition unit 101 may acquire the information indicating the payment method input by the customer on the input screen of the payment method.

Next, a method by which the customer information acquisition unit 101 acquires a product registration method of a customer will be described.

Similarly to the acquisition of the information indicating the payment method, the customer information acquisition unit 101 may acquire the information indicating the product registration method to be used input by the customer. As a product registration method to be input by the customer, for example, an input screen indicating an option such as “product registered” or “perform product registration with the payment device” may be displayed on the terminal device or the display device. Specifically, the information indicating the product registration method to be input by the customer may be information selected and operated by the customer from an input screen indicating an option such as “perform product registration with the payment device” or “self-scan”. The self-scan is a product registration method in which a customer registers a purchased product by scanning using a terminal device while shopping in a store as described above.

Alternatively, the customer information acquisition unit 101 may specify the product registration method of the customer based on the image obtained by photographing the customer. The image obtained by photographing the customer includes a shopping basket and a shopping cart owned by the customer. It is assumed that the shopping basket and the shopping cart for self-scanning are provided with a sensor and a terminal device for product registration. As a result, the customer information acquisition unit 101 specifies, by image recognition, whether the shopping basket or the shopping cart included in the image is for self-scan stored in advance or a normal shopping cart not for self-scan. In a case where the customer does not have the shopping basket or a shopping cart, the customer information acquisition unit 101 may specify that the method is a method of performing product registration in the payment device instead of self-scanning.

Next, the status acquisition unit 102 is an example of a status acquisition means that acquires the status of the payment device including at least one of the information indicating the payment method available in the payment device and the information indicating the registration method of the purchased product available in the payment device and the operation information of the payment device. The status of the payment device is information indicating the status of the payment device. As described above, the status of the payment device includes at least one of the information indicating the payment method available in the payment device and the information indicating the registration method of the purchased product available in the payment device, and the operation information of the payment device.

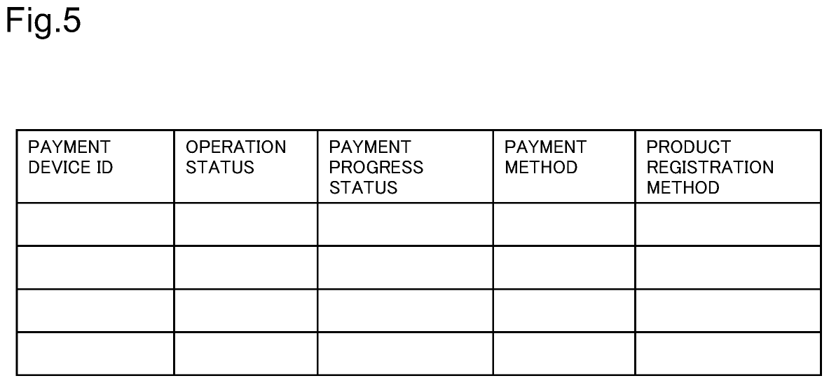

FIG. 5 is an example of data indicating the status of the payment device. The status of the payment device illustrated in FIG. 5 is information in which the operation status, the payment progress status, the payment method, and the product registration method are associated with the ID of each payment device. Specifically, the status acquisition unit 102 acquires the status of the payment device as illustrated in FIG. 5 based on the POS data.

In the status of the payment device, the operation information includes the operation status and the payment progress status. The operation status of the payment device is information indicating whether the payment device is in operation or stopped. The payment progress status of the payment device is information indicating the payment progress status of the payment device. The payment progress status may be, for example, availability product registration, payment, or the like, but is not limited thereto.

The information indicating the payment method available in the payment device and the information indicating the available product registration method may be stored in the payment device database in advance for each device. In this case, the status acquisition unit 102 may acquire information indicating the payment method available in the payment device and information indicating the available product registration method from the payment device database or the like.

Alternatively, the payment method available in the payment device and the available product registration method may be switched by a clerk who operates the POS terminal. In this case, the POS data includes that the payment method or the product registration method cannot be temporarily used due to a communication failure, a service stop, or the like. Therefore, the status acquisition unit 102 may acquire information indicating the currently available payment method and information indicating the product registration method included in the status from the POS data.

The output unit 103 is an example of an output means that outputs guidance information indicating the payment device conforming to the customer information based on the acquired customer information and status.

The output unit 103 outputs guidance information that conforms to the customer information and indicates an available payment device. More specifically, the output unit 103 outputs guidance information indicating a payment device whose operation status is in operation and whose payment progress status is vacant among the payment devices associated with an available payment method or product registration method conforming to the information indicating the payment method and the information indicating the product registration method included in the customer information.

Alternatively, the output unit 103 may output guidance information indicating a payment device that conforms to the customer information and will be able to be guided to the customer soon. The payment device that can be guided to the customer soon may be, for example, a payment device in which the payment progress status is a status such as payment, receipt issuance, and change payment.

Furthermore, in a case where there are a plurality of payment devices conforming to the customer information, the output unit 103 may output guidance information indicating the payment device conforming to the customer information based on the distance from the position of the customer to the payment device conforming to the customer information. For example, in a case where there are a plurality of payment devices conforming to the customer information, the output unit 103 may output guidance information indicating a payment device having a short distance from a place where the customer waits for the payment device to the payment device conforming to the customer information among the payment devices conforming to the customer information. As a result, the customer can move to the payment device to be used immediately. Alternatively, for example, in a case where there are a plurality of payment devices conforming to the customer information, the output unit 103 may output guidance information indicating a payment device having a long distance from a place where the customer waits for the payment device to the payment device conforming to the customer information among the payment devices conforming to the customer information. As a result, the customer moving to the payment device can move smoothly.

The guidance information includes information that enables a customer to specify an available payment device. The information with which the customer can specify the available payment device is, for example, the place of the payment device or the number of the payment device. These pieces of information are easily recognized by the customer when displayed on the screen.

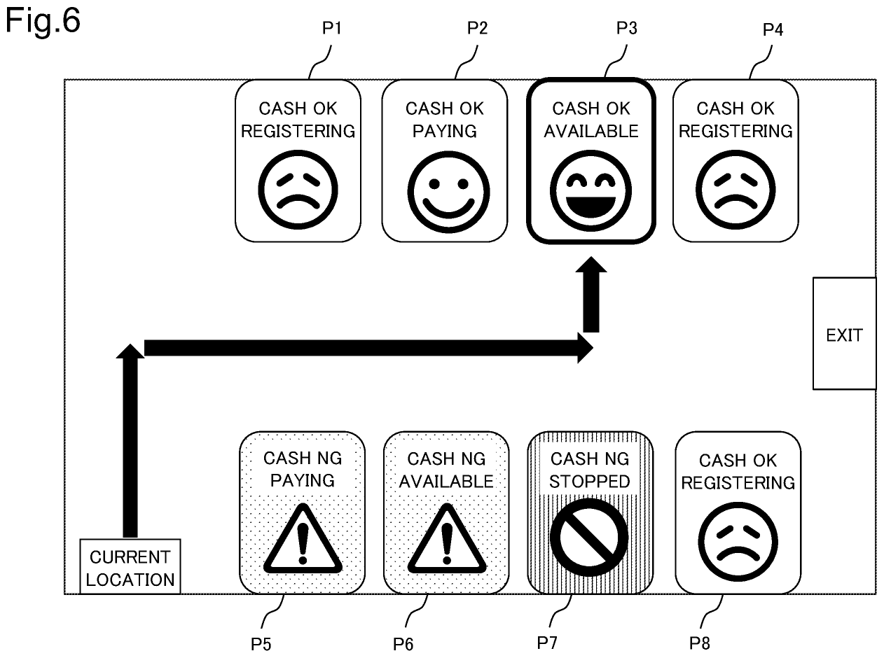

FIG. 6 is an output example of the guidance information. In FIG. 6, each of P1 to P8 is a payment device. The output unit 103 may indicate the place of the available payment device by color, character, symbol, blinking of light, or the like in a diagram illustrating the current location and the place of each payment device. Alternatively, as indicated by an arrow in FIG. 6, the output unit 103 may indicate a route to the payment device as the payment device guidance information. As illustrated in FIG. 6, the output unit 103 may indicate the status of the payment device. As a result, the customer can select an appropriate payment device by himself/herself even when the payment device guided due to an input mistake of the customer information or the like is wrong.

Even in a case where there is no available payment device, the output unit 103 may display information indicating the place and status of the payment device as illustrated in FIG. 6 in advance. As a result, the customer can see the waiting time. In this case, the status acquisition unit 102 may acquire the status of the payment device at predetermined intervals such as every 10 seconds and every 1 second, and the output unit 103 may update the display of the information indicating the place and the status of the payment device as needed based on the acquired status.

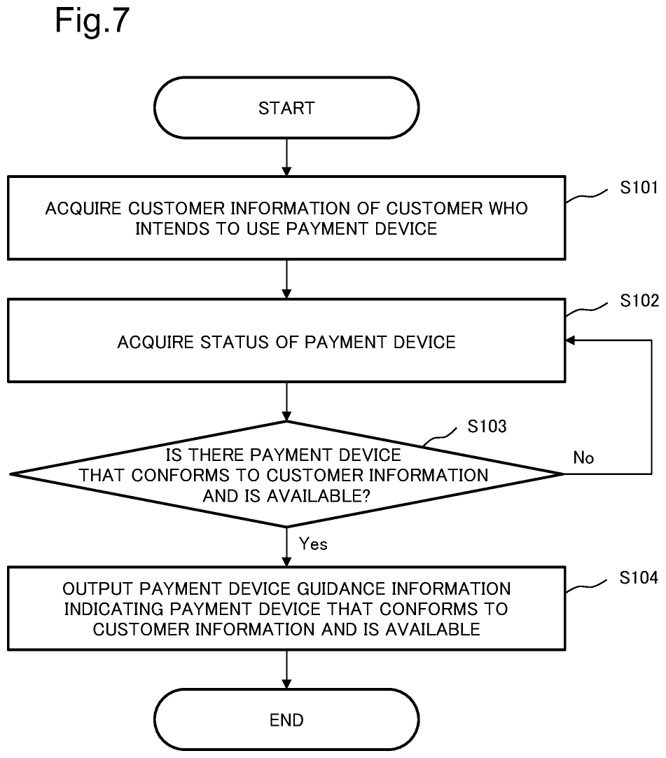

The operation of the information processing apparatus 100 configured as described above will be described with reference to the flowchart of FIG. 7.

FIG. 7 is a flowchart illustrating an outline of an operation of the information processing apparatus 100 according to the example embodiment in a case where there is one customer waiting for the payment device.

As illustrated in FIG. 7, first, the customer information acquisition unit 101 acquires customer information of a customer who intends to use the payment device (Step S101).

Next, the status acquisition unit 102 acquires the status of the payment device (Step S102).

Next, based on the status of the payment device acquired in Step S102, the output unit 103 determines whether there is a payment device that conforms to the customer information acquired in Step S101 and is available (Step S103). The available payment device may be an available payment device.

In a case where there is a payment device that conforms to the customer information (Step S103: Yes), the output unit 103 outputs payment guidance information that conforms to the customer information and indicates an available payment device (Step S104).

In a case where there is no payment device matching the customer information (Step S103: No), the output unit 103 returns to Step S102 again and acquires the status of the payment device. In a case of Step S103: No, the output unit 103 may output information indicating that there is no payment device that can be guided at that time point, such as “please wait”. Alternatively, based on the status of the payment device, for example, in a case where the status of the payment device compatible with the customer information indicates that the receipt has been issued, the output unit 103 may output information regarding the waiting time of the customer, such as “X-th payment device will be available soon”.

Thus, the information processing apparatus 100 ends the series of operations. In a case where there are a plurality of customers who wait for the payment device, the information processing apparatus 100 repeats a series of operations. The order of the operations in Steps S101 and S102 is not limited. Alternatively, Step S102 may be performed at any time.

In the information processing apparatus according to the present example embodiment described above, the customer information acquisition unit acquires at least one of the payment method and the product registration method of the customer who intends to use the payment device, and the output unit outputs the guidance information indicating the payment device whose status of the payment device matches the customer information.

As a result, the information processing apparatus according to the present example embodiment can guide the customer to an appropriate payment device.

### Modification

In the example embodiment, when the customer is heading to a certain payment device, it is indicated that the status of the payment device at that time point is available. However, since the payment device is used by the customer, it is not possible to guide the customer waiting for availability of the payment device next.

Therefore, in the information processing apparatus 100, the status acquisition unit 102 may acquire information indicating a payment device to be used by a customer who heads for the payment device as one status of the payment device. For example, the status acquisition unit 102 receives an input of a selection operation of a payment device to be used by the customer from a terminal device or a display device provided in a place where the payment device is to be waited. As a result, the status acquisition unit 102 acquires a status indicating that the payment progress status of the payment device is available and is scheduled to be used based on the POS data and the input by the customer. In this case, the status indicating the payment progress status of the payment device is, for example, “currently moving”. In this way, the output unit 103 can prevent the payment device used by the next person from being output as the payment device conforming to the customer information. That is, the information processing apparatus 100 can indicate a payment device that can be more appropriately used by a customer. In the display of the status of each payment device, the next person is prevented from erroneously moving to the payment device being moved, and the customer around the payment device moves smoothly.

### Hardware Configuration

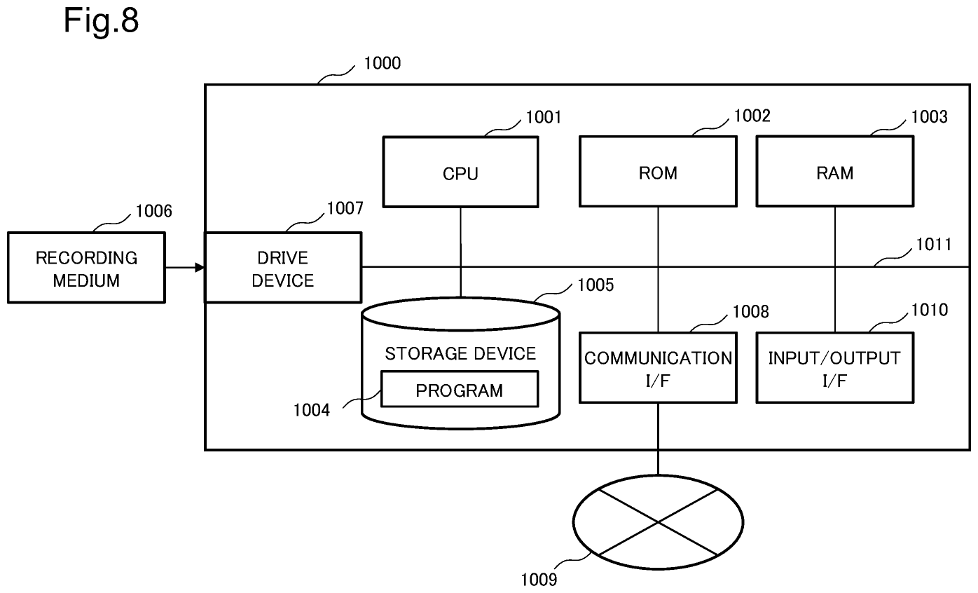

Some or all of components of each apparatus or system in each example embodiment of the present disclosure described above are achieved by, for example, an arbitrary combination of the information processing apparatus 1000 and a program as illustrated in FIG. 8. The information processing apparatus 1000 includes the following configuration as an example.
CPU(Central Processing Unit) 1001
ROM(Read Only Memory) 1002
RAM(Random Access Memory) 1003
Program 1004 loaded into RAM 1003
Storage device 1005 storing program 1004
Drive device 1007 that reads and writes recording medium 1006
Communication I/F 1008 connected to communication network 1009
Input/output I/F 1010 for inputting/outputting data
Bus 1011 connecting each component

The I/F is an abbreviation of Interface.

Each component of each device or system in each example embodiment is achieved by the CPU 1001 acquiring and executing a program for achieving these functions. The program for achieving the function of each component of each device is stored in the storage device 1005 or the RAM 1003 in advance, for example, and is read by the CPU 1001 as necessary. The program 1004 may be supplied to the CPU 1001 via a communication network, or may be stored in advance in the recording medium 1006, and the drive device 1007 may read the program and supply the program to the CPU 1001.

There are various modifications of the implementation method of each device. For example, each device or system may be achieved by an arbitrary combination of the information processing apparatus 1000 and the program separate for each component. A plurality of components included in each device may be achieved by an arbitrary combination of one information processing apparatus 1000 and a program.

Some or all of the components of each device or system are achieved by general-purpose or dedicated circuitry including a processor or the like, or a combination thereof. The circuitry is, for example, a CPU, a graphics processing unit (GPU), a field programmable gate array (FPGA), or a large scale integration (LSI). The LSI is, for example, an LSI dedicated to artificial intelligence (AI) processing. These may be configured by a single chip or may be configured by a plurality of chips connected via a bus. Some or all of the components of each device may be achieved by a combination of the above-described circuitry or the like and a program.

In a case where some or all of components of each device or system are achieved by a plurality of information processing apparatuses, circuits, and the like, the plurality of information processing apparatuses, circuits, and the like may be arranged in a centralized manner or in a distributed manner. For example, the information processing apparatus, the circuit, and the like may be achieved as a form in which each is connected via a communication network, such as a client and server system or a cloud computing system.

A plurality of payment devices may be provided in a store. In recent years, payment devices provided in stores have been diversified.

For example, an available payment method or a method of registering a purchased product may be different depending on the payment device. The customer selects, from the plurality of payment devices, a payment device that can use a payment method that the customer desires to use or a method of registering a purchased product.

If the payment device used by the customer does not support the payment method or product registration method that the customer wishes to use, the customer will have to search for another payment device or move to another payment device. This is a hassle for the customer.

An example advantage according to this disclosure is that it can guide the customer to an appropriate payment device.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents. Various modifications that can be understood by those skilled in the art can be made to the configuration and details of the present disclosure within the scope of the present disclosure.

Although the plurality of operations are described in order in the form of a flowchart, the order of description does not limit the order of executing the plurality of operations. Therefore, when each example embodiment is implemented, the order of the plurality of operations may be changed within a range that does not interfere in content. Further, it is noted that the inventor's intent is to retain all equivalents of the claimed invention even if the claims are amended during prosecution.

### Supplementary Note

### Supplementary Note 1

An information processing apparatus including:

a customer information acquisition means that acquires at least one of information indicating a payment method used by a customer who intends to use a payment device and information indicating a registration method of a product of the customer as customer information;

a status acquisition means that acquires a status of a payment device including at least one of information indicating a payment method available in the payment device and information indicating a registration method of a product available in the payment device and an operation status of the payment device; and

an output means that outputs guidance information indicating a payment device conforming to the customer information based on the customer information and the status.

### Supplementary Note 2

The information processing apparatus according to Supplementary Note 1, in which the output means outputs the guidance information and information indicating the status of each payment device to a display device.

### Supplementary Note 3

The information processing apparatus according to Supplementary Note 1 or 2, in which the customer information acquisition means acquires information indicating the payment method based on an input of the payment method to a terminal device by the customer.

### Supplementary Note 4

The information processing apparatus according to any one of Supplementary Notes 1 to 3, in which the customer information acquisition means acquires information indicating the payment method associated with identification information for identifying the customer

### Supplementary Note 5

The information processing apparatus according to Supplementary Note 4, in which the identification information is a face image of the customer, and
the customer information acquisition means acquires information indicating the payment method associated with the customer information authenticated by the face image.

### Supplementary Note 6

The information processing apparatus according to Supplementary Note 4 or 5, in which the identification information is an identification number assigned to the customer, and
the customer information acquisition means acquires information indicating the payment method associated with an identification number of the customer.

### Supplementary Note 7

The information processing apparatus according to any one of Supplementary Notes 1 to 6, in which the customer information acquisition means specifies the registration method of the product of the customer based on an image obtained by photographing the customer.

### Supplementary Note 8

The information processing apparatus according to any one of Supplementary Notes 1 to 7, in which the output means outputs, in a case where there are a plurality of payment devices conforming to the customer information, the guidance information indicating a payment device conforming to the customer information according to a distance to the payment device conforming to the customer information.

### Supplementary Note 9

The information processing apparatus according to any one of Supplementary Notes 1 to 8, in which the output means further outputs a route to a payment device conforming to the customer information.

### Supplementary Note 10

An information processing method by a computer, the information processing method including:

acquiring at least one of information indicating a payment method used by a customer who intends to use a payment device and information indicating a registration method of a product of the customer as customer information;

acquiring a status of a payment device including at least one of information indicating a payment method available in the payment device and information indicating a registration method of a product available in the payment device and an operation status of the payment device; and

outputting guidance information indicating a payment device conforming to the customer information based on the customer information and the status.

### Supplementary Note 11

A recording medium that stores an information processing program for causing a computer to execute:

acquiring at least one of information indicating a payment method used by a customer who intends to use a payment device and information indicating a registration method of a product of the customer as customer information;

acquiring a status of a payment device including at least one of information indicating a payment method available in the payment device and information indicating a registration method of a product available in the payment device and an operation status of the payment device; and

outputting guidance information indicating a payment device conforming to the customer information based on the customer information and the status.

1. An information processing apparatus comprising:
a memory storing instructions; and
one or more processors configured to execute the instructions to:
acquire at least one of information indicating a payment method used by a customer who intends to use a payment device and information indicating a registration method of a product of the customer as customer information;
acquire a status of a payment device including at least one of information indicating a payment method available in the payment device and information indicating a registration method of a product available in the payment device and an operation status of the payment device; and
output guidance information indicating a payment device conforming to the customer information based on the customer information and the status.

2. The information processing apparatus according to claim 1, wherein
the one or more processors are further configured to execute the instructions to:
output the guidance information and information indicating the status of each payment device to a display device.

3. The information processing apparatus according to claim 1, wherein
the one or more processors are further configured to execute the instructions to:
acquire information indicating the payment method based on an input of the payment method to a terminal device by the customer.

4. The information processing apparatus according to claim 1, wherein
the one or more processors are further configured to execute the instructions to:
acquire information indicating the payment method associated with identification information for identifying the customer.

5. The information processing apparatus according to claim 4,
wherein the identification information is a face image of the customer, and
the one or more processors are further configured to execute the instructions to:
acquire information indicating the payment method associated with the customer information authenticated by the face image.

6. The information processing apparatus according to claim 4,
wherein the identification information is an identification number assigned to the customer, and
the one or more processors are further configured to execute the instructions to:
acquire information indicating the payment method associated with an identification number of the customer.

7. The information processing apparatus according to claim 1, wherein
the one or more processors are further configured to execute the instructions to:
specify the registration method of the product of the customer based on an image obtained by photographing the customer.

8. The information processing apparatus according to claim 1, wherein
the one or more processors are further configured to execute the instructions to:
output, in a case where there are a plurality of payment devices conforming to the customer information, the guidance information indicating a payment device conforming to the customer information according to a distance to the payment device conforming to the customer information.

9. The information processing apparatus according to claim 1, wherein
the one or more processors are further configured to execute the instructions to:
further output a route to a payment device conforming to the customer information.

10. An information processing method by a computer, the information processing method comprising:
acquiring at least one of information indicating a payment method used by a customer who intends to use a payment device and information indicating a registration method of a product of the customer as customer information;
acquiring a status of a payment device including at least one of information indicating a payment method available in the payment device and information indicating a registration method of a product available in the payment device and an operation status of the payment device; and
outputting guidance information indicating a payment device conforming to the customer information based on the customer information and the status.

11. A non-transitory computer-readable recording medium that records a program for causing a computer to execute:
acquiring at least one of information indicating a payment method used by a customer who intends to use a payment device and information indicating a registration method of a product of the customer as customer information;
acquiring a status of a payment device including at least one of information indicating a payment method available in the payment device and information indicating a registration method of a product available in the payment device and an operation status of the payment device; and
outputting guidance information indicating a payment device conforming to the customer information based on the customer information and the status.
